(19) United States
(12) Patent Application Publication
(10) Pub. No.: US 2008/0142444 A1
(43) Pub. Date: Jun. 19, 2008

(54) Liquid chromatograph apparatus

(75) Inventor: Kosaku Toyosaki, Ishioka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/987,181

(22) Filed: Nov. 28, 2007

(30) Foreign Application Priority Data
Dec. 1, 2006 (JP) 2006-325552

(51) Int. Cl. B01D 15/14

(52) U.S. Cl. 210/656; 210/140; 210/85; 210/93

(57) ABSTRACT

A liquid chromatograph apparatus capable of eliminating a deviation of measurement results originating from an instrumental error is provided.

According to the present invention, a mobile phase arrival time T of the liquid chromatograph apparatus is determined in advance. The mobile phase arrival time T is a time taken for a mobile phase mixed by a pump to reach a detector. When operating the liquid chromatograph apparatus, sample injection into the mobile phase is started after a time corresponding to the mobile phase arrival time T passes. Collection of data output from the detector is started after a predetermined time passes after starting the sample injection into the mobile phase.

### BACKGROUND OF THE INVENTION

1. Field of the invention

The present invention relates to a liquid chromatograph apparatus, and in particular, relates to a liquid chromatograph apparatus suitable for executing the gradient elution method for the purpose of conducting a multi-component simultaneous analysis.

2. Description of the Related Art

In a liquid chromatograph apparatus, gradient liquid feeding is performed by which a plurality of solutions at a microliter level per minute are mixed and supplied. The gradient liquid feeding is a technology to continuously feed a mixed solution at a constant flow rate while varying the mixing ratio of a plurality of solutions continuously or in stages with time. Commonly, a mixed solution of two solutions is fed.

In recent years, there are cases in which many liquid chromatograph apparatuses are operated simultaneously, a large amount of measurement results are generated, and target components therefrom are analyzed. If, in such cases, there are instrumental errors among apparatuses, measurement results include a deviation originating from such instrumental errors. Correct analysis results cannot be obtained from measurement results having such a deviation.

Therefore, when analyzing target components using measurement results by a liquid chromatograph apparatus, a deviation originating from instrumental errors included in measurement results needs to be reduced.

Japanese Patent Application Laid-Open No. 2002-243712 discloses a correction method of deviation of the mixing ratio by the gradient elution method.

The technology described in Japanese Patent Application Laid-Open No. 2002-243712 is a correction method for a deviation of the mixing ratio for a pump unit and has no function to eliminate a deviation of measurement results originating from an instrumental error of the liquid chromatograph apparatus.

An object of the present invention is to provide a liquid chromatograph apparatus that can eliminate a deviation of measurement results originating from an instrumental error.

### SUMMARY OF THE INVENTION

According to the present invention, a mobile phase arrival time T of a liquid chromatograph is determined in advance. The mobile phase arrival time T is a time taken for a mobile phase mixed by a pump to reach an analytical column. When operating the liquid chromatograph, sample injection into the mobile phase is started when a time corresponding to the mobile phase arrival time T passes after starting gradient liquid feeding. Collection of data output from a detector is started immediately after starting sample injection into the mobile phase or after a predetermined time passes.

According to the present invention, a deviation of measurement results originating from an instrumental error can be eliminated.

### BRIEF DESCRIPTION OF THE DRAWINGS

FIG. 1 is a diagram showing a configuration example of a liquid chromatograph apparatus according to the present invention;

FIG. 2 is a diagram showing a configuration example of a liquid chromatograph according to the present invention;

FIG. 3 is a diagram showing an operation schedule of the liquid chromatograph apparatus according to the present invention;

FIG. 4 is a diagram exemplifying an example of an operation method of the liquid chromatograph apparatus according to the present invention;

FIG. 5 is a diagram showing a configuration example of a high-speed liquid chromatograph using a post column derivatization method according to the present invention;

FIGS. 6A and 6B are diagrams showing a configuration example of an auto sampler of the liquid chromatograph apparatus according to the present invention;

FIGS. 7A and 7B are diagrams showing simulation results of the operation method of the liquid chromatograph apparatus according to the present invention;

FIG. 8 is a diagram exemplifying an example of a dwell volume setting screen of the liquid chromatograph apparatus according to the present invention;

FIGS. 9A, 9B and 9C are diagrams showing experimental results when no dwell volume is set; and

FIGS. 10A, 10B and 10C are diagrams showing experimental results when the dwell volume is set.

### DESCRIPTION OF THE PREFERRED EMBODIMENTS

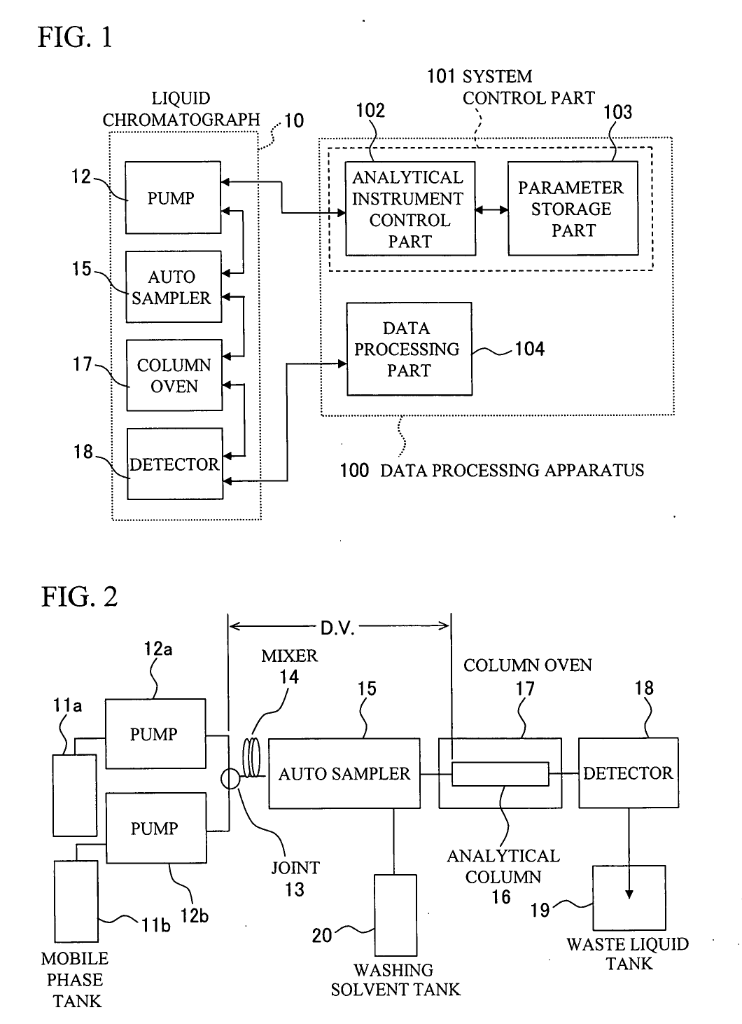

An overview of a liquid chromatograph apparatus according to the present invention is described with reference to FIG. 1. The liquid chromatograph apparatus in the present example comprises a liquid chromatograph 10 and a data processing apparatus 100. The liquid chromatograph 10 comprises a pump 12, an auto sampler 15, a column oven 17, and a detector 18 and the like. The data processing apparatus 100 comprises a system control part 101 and a data processing part 104. The system control part 101 comprises an analytical instrument control part 102 and a parameter storage part 103.

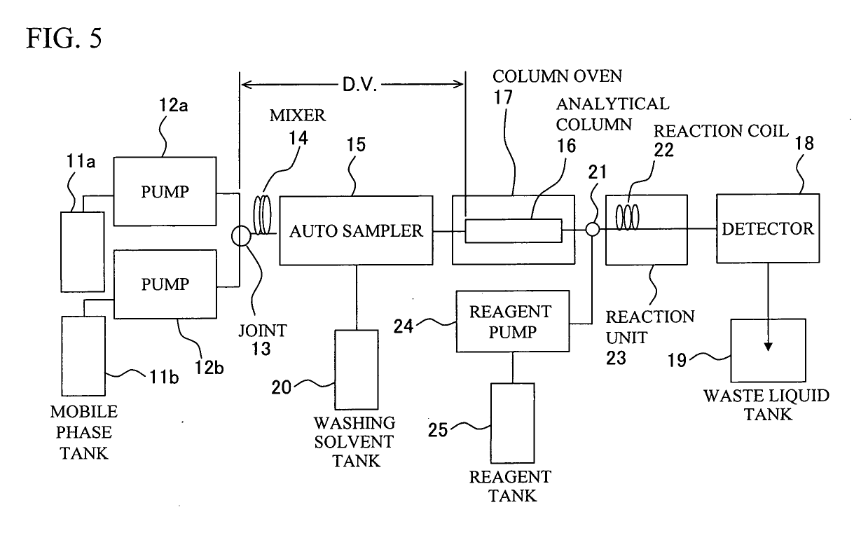

Details of the liquid chromatograph 10 will be described below with reference to FIG. 2 and FIG. 5. Here, the data processing apparatus 100 will be described.

The analytical instrument control part 102 gets parameters being input from the parameter storage part 103 and transmits a control signal to the pump 12 to perform gradient liquid feeding. The gradient liquid feeding is performed according to a gradient program created in advance. The parameter storage part 103 stores a gradient liquid feeding start time, sample injection start time, mobile phase arrival time and the like, which will be described later. The data processing part 104 performs processing of output from the detector 18 and generates analysis results.

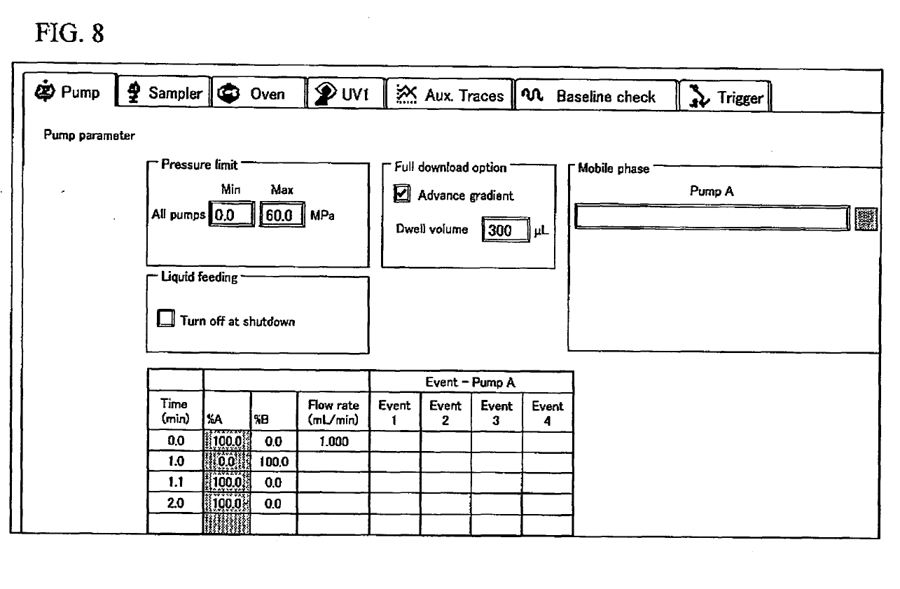

Though not shown in FIG. 1, the liquid chromatograph apparatus in the present example comprises an input device into which data and instructions are input by a user and a display device for displaying a dwell volume setting screen used for inputting a dwell volume. FIG. 8 shows an example of the dwell volume setting screen.

A configuration example of the liquid chromatograph according to the present invention will be described with reference to FIG. 2. The liquid chromatograph in the present example comprises two mobile phase tanks 11a and 11b, two pumps 12a and 12b, a joint 13, a mixer 14, an auto sampler 15, an analytical column 16, a column oven 17 which is a thermoregulator of the analytical column 16, the detector 18, a waste liquid tank 19, and a washing solvent tank 20. The two mobile phase tanks 11a and 11b contain different mobile phases. The pumps 12a and 12b are gradient liquid feeding pumps and can feed a fixed amount of liquid while changing the mixing ratio of two mobile phases. Mobile phases contained in the two mobile phase tanks 11 a and 11b are sucked by the two pumps before being fed to the joint 13. The two mobile phases are mixed by the joint 13. A mixed liquid at a constant flow rate is fed to the mixer 14 from the joint 13. The mixed liquid is mixed by passing through the mixer 14.

The mobile phase from the mixer 14 is fed to the auto sampler 15. A sample is injected into the mobile phase by the auto sampler 15. The mobile phase into which the sample has been injected is fed to the analytical column 16. Components contained in the sample are separated by the analytical column 16. The analytical column 16 is maintained at a constant temperature by the column oven 17. Components separated by the analytical column 16 are detected by the detector 18. A waste liquid from the detector 18 is received by the waste liquid tank 19. The auto sampler 15 is washed by a washing solvent contained in the washing solvent tank 20.

Here, the mobile phase arrival time of the liquid chromatograph is defined by the following formula:

T=DV/F.R. Formula I
T: Mobile phase arrival time (s)
DV: Dwell volume (μL)
F.R.: Pump flow rate (Flow rate) (μL/s)

The dwell volume DV is a total volume of a path of the mobile phase from the joint 13 to the analytical column 16. If, for example, the volume of the mixer 14 is Vm and that of a pipe is Vp, DV=Vm+Vp. The pump flow rate is a flow rate of the mixed liquid of mobile phases from the pumps. The mobile phase arrival time T of the two pumps is a time taken for a mobile phase to reach the analytical column 16 after starting from the joint 13 while the flow channel from the joint 13 to the analytical column 16 is filled with the mobile phase. The mobile phase arrival time T is a time taken for a mobile phase filling up the flow channel from the joint 13 to the analytical column 16 to be completely replaced by a new mobile phase.

The dwell volume DV and the pump flow rate F.R. are constant values determined for each liquid chromatograph. Therefore, the mobile phase arrival time T is a constant value determined for each liquid chromatograph. Though it is difficult to estimate the dwell volume DV exactly, the mobile phase arrival time can actually be measured.

First, a standard apparatus of the liquid chromatograph apparatus is assumed. The mobile phase arrival time is determined by using the standard apparatus. This time is called the standard mobile phase arrival time To. Next, the mobile phase arrival time of the liquid chromatograph apparatus used for actual analysis is determined. This time is called T1. A deviation of the mobile phase arrival time of the liquid chromatograph apparatus used for analysis is determined by the following formula:

ΔT=T1−T₀

If the pump flow rate F.R. is assumed to be constant for all apparatuses, the deviation ΔT corresponds to a deviation of the dwell volume DV. That is, the deviation ΔT represents an instrumental error of the liquid chromatograph apparatus. By eliminating the influence of the deviation ΔT, measurement data without such instrumental error can be obtained.

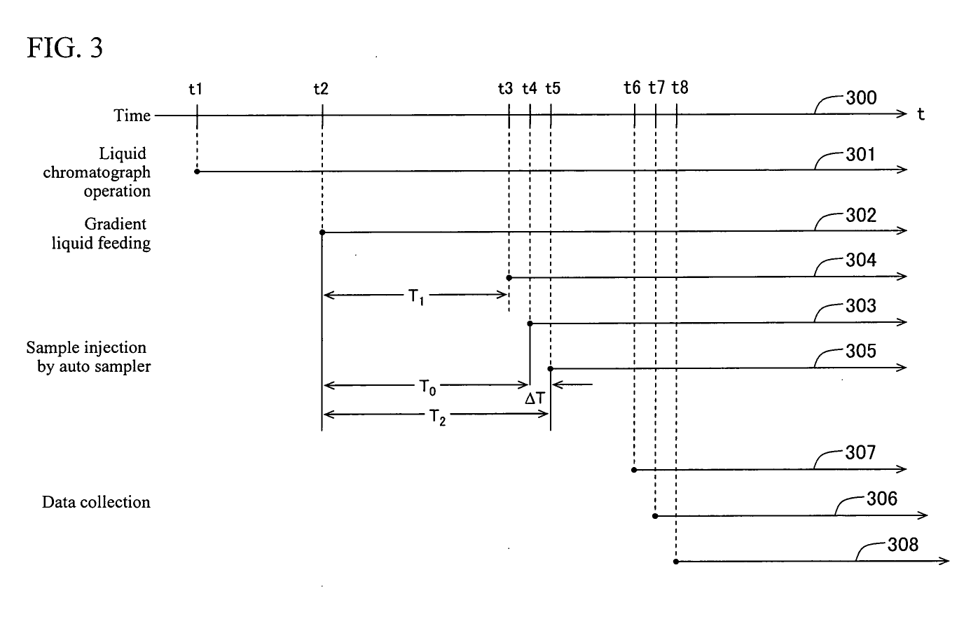

The operation method of the liquid chromatograph apparatus according to the present invention will be described with reference to FIG. 3. Here, an operation of three liquid chromatograph apparatuses is taken as an example to describe the operation method. The first liquid chromatograph apparatus has an instrumental error and the mobile phase arrival time thereof is assumed to be T1. The second liquid chromatograph apparatus is a liquid chromatograph apparatus without instrumental error, that is, a standard liquid chromatograph apparatus. The standard mobile phase arrival time is assumed to be T₀. The third liquid chromatograph apparatus has an instrumental error and the mobile phase arrival time thereof is assumed to be T2. Here, T1<T₀<T2. That is, the mobile phase arrival time T1 of the first liquid chromatograph apparatus is smaller than the standard mobile phase arrival time T₀ and the mobile phase arrival time T2 of the third liquid chromatograph apparatus is greater than the standard mobile phase arrival time T₀.

These mobile phase arrival times T1 and T2 and the standard mobile phase arrival time T₀ are predetermined.

FIG. 3 is a time chart of operation of these liquid chromatograph apparatuses. This time chart includes a time axis 300, an operation of liquid chromatograph 301, gradient liquid feeding 302, sample injection by an auto sampler 303 to 305, and data collection 306 to 308. As shown in the figure, the operation of the liquid chromatograph is started at time t1. That is, the pumps 12a and 12b are operated to supply a mobile phase. However, at this point, gradient liquid feeding is not yet started. Therefore, only one mobile phase is supplied from the pumps 12a and 12b. For example, the first mobile phase is supplied. The first mobile phase passes through the joint 13, mixer 14, auto sampler 15, and analytical column 16 to flow up to the detector 18. In this manner, the path from the joint 13 to the detector 18 is filled with the first mobile phase. Next, gradient liquid feeding is started at time t2. A mixed liquid of two mobile phases is supplied at a constant flow rate from the two pumps 12a and 12b. The mixed liquid is obtained by mixing a second mobile phase with the first mobile phase at a predetermined ratio. The mixing ratio of the second mobile phase to the first mobile phase increases with time. The flow rate remains constant even if the mixing ratio of two mobile phases changes. Next, a sample is injected into the mobile phases by the auto sampler 15. Here, three cases will be described.

First, a case of the first liquid chromatograph apparatus will be described. As indicated by a line 304, sample injection by the auto sampler 15 is started at time t3 when the time T1 passes after time t2 when the gradient liquid feeding is started. At time t3, the mixed liquid of two mobile phases by the gradient liquid feeding just reaches the detector 18. Next, as indicated by a line 307, data output from the detector 18 is collected at time t6.

Next, a case of the second liquid chromatograph apparatus, that is, the standard apparatus will be described. As indicated by a line 303, sample injection by the auto sampler 15 is started at time t4 when the time To passes after time t2 when the gradient liquid feeding is started. At time t4, the mixed liquid of two mobile phases by the gradient liquid feeding just reaches the detector 18. Next, as indicated by a line 306, data output from the detector 18 is collected at time t7.

A case of the third liquid chromatograph apparatus will be described. As indicated by a line 305, sample injection by the auto sampler 15 is started at time t5 when the time T2 passes after time t2 when the gradient liquid feeding is started. At time t5, the mixed liquid of two mobile phases by the gradient liquid feeding just reaches the detector 18. Next, as indicated by a line 308, data output from the detector 18 is collected at time t8.

In the present example, as described above, the start time of gradient liquid feeding is determined based on the mobile phase arrival time. Thus, a deviation of the mobile phase arrival time representing an instrumental error of the liquid chromatograph can be eliminated. Therefore, data output from the detector 18 will not be affected by such an instrumental error.

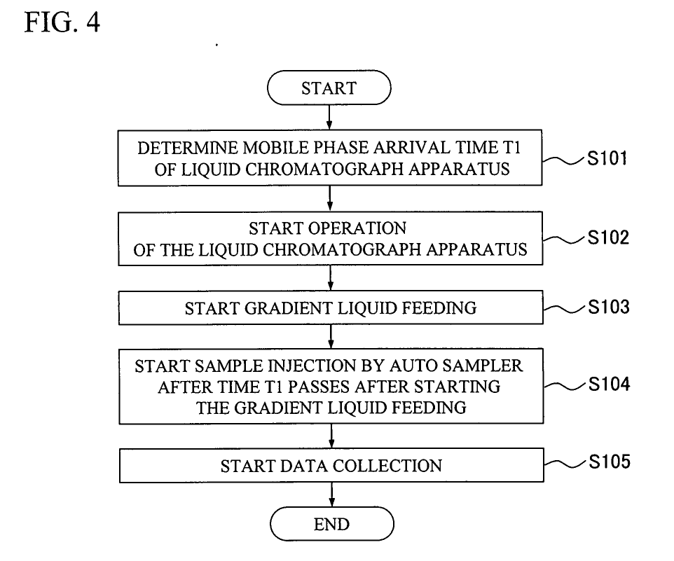

The operation method of the liquid chromatograph apparatus according to the present invention will be described with reference to FIG. 4. In step S101, the mobile phase arrival time T1 of a liquid chromatograph apparatus to be used for analysis is determined. In step S102, the operation of the liquid chromatograph apparatus is started. At first, gradient liquid feeding is not performed. Thus, one mobile phase is fed. Here, the first mobile phase is fed. When the first mobile phase passes through the joint 13, mixer 14, auto sampler 15, and analytical column 16 to flow up to the detector 18, gradient liquid feeding is started in step S103. The second mobile phase is added to the first mobile phase at a predetermined ratio. The flow rate remains constant even if the mixing ratio of two mobile phases changes. In step S104, when the time Ti passes after the gradient liquid feeding is started, sample injection into the mobile phase by the auto sampler is started. In step S105, collection of output data from the detector is started simultaneously with the sample injection or after a predetermined time passes.

Another configuration example of the liquid chromatograph according to the present invention will be described with reference to FIG. 5. The liquid chromatograph in the present example is a high-speed liquid chromatograph using the post-column derivatization method. The high-speed liquid chromatograph in the present example comprises the two mobile phase tanks 11a and 11b, the two pumps 12a and 12b, the joint 13, the mixer 14, the auto sampler 15, the analytical column 16, the column oven 17, which is a thermoregulator of the analytical column 16, the detector 18, the waste liquid tank 19, the washing solvent tank 20, a joint 21, a reaction coil unit 23 having a reaction coil 22, a reagent pump 24, and a reagent tank 25.

In comparison with the example shown in FIG. 2, the liquid chromatograph in the present example is different in processing after the analytical column 16. In the present example, a reagent contained in the reagent tank 25 is supplied to the joint 21 by the reagent pump 24. In the joint 21, components separated by the analytical column 16 and the reagent supplied from the reagent pump 24 are mixed. The mixed liquid is fed to the reaction coil 22. In the process of passing through the reaction coil 22, separated components and the reagent in the mixed liquid react completely to generate reaction products. The reaction products are detected by the detector 18.

In the present example, the dwell volume DV is the total volume of the path of the mobile phase from the joint 13 to the analytical column 16. If, for example, the volume of the mixer 14 is Vm and that of the pipe is Vp, DV=Vm+Vp.

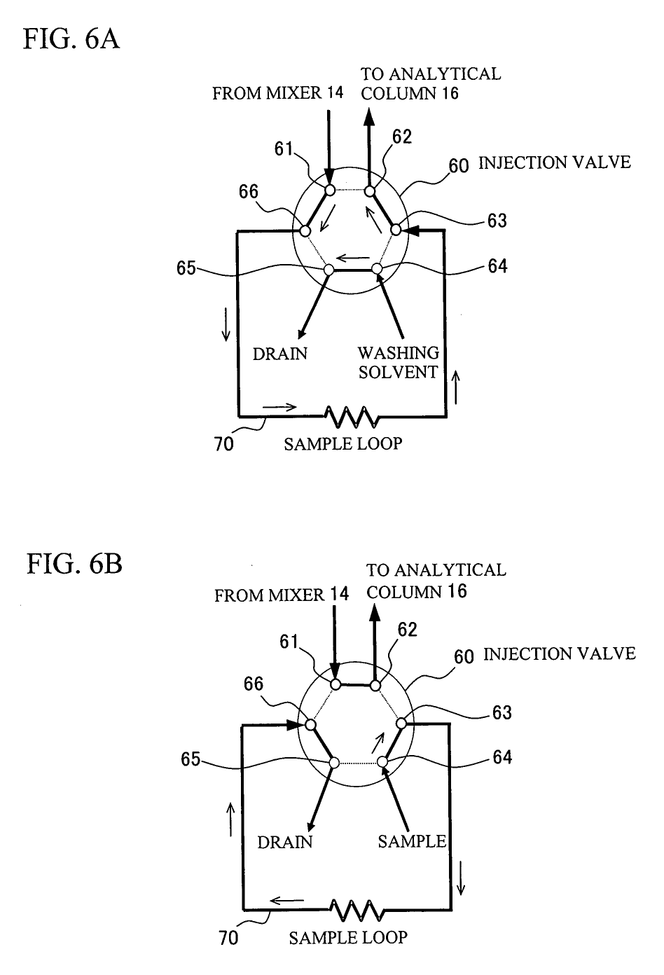

An overview of the auto sampler 15 will be described with reference to FIGS. 6A and 6B. The auto sampler 15 comprises an injection valve 60 and a sample loop 70. The injection valve 60 comprises six ports 61 to 66. The first port 61 is connected to the mixer 14 and the second port 62 is connected to the analytical column 16. The third port 63 and the sixth port 66 are connected by the sample loop 70. A washing solvent or sample is injected by a needle (not shown) through the fourth port 64. The fifth port 65 is connected to a drain.

As shown in FIG. 6A, when the operation of the liquid chromatograph is started, the second port 62 and the third port 63 are connected, the fourth port 64 and the fifth port 65 are connected, and the sixth port 66 and the first port 61 are connected. Therefore, the mobile phase supplied from the mixer 14 is fed to the analytical column 16 via the first port 61, sixth port 66, sample loop 70, third port 63, and second port 62. The washing solvent from the needle, on the other hand, is introduced by the fourth port 64 and discharged from the fifth port 65 into the drain. Therefore, in this state, a mobile phase into which no sample has been injected passes through the auto sampler 15.

Next, as shown in FIG. 6B, the sample loop is filled with a sample. The first port 61 and the second port 62 are connected, the third port 63 and the fourth port 64 are connected, and the fifth port 65 and the sixth port 66 are connected. Therefore, the mobile phase supplied from the mixer 14 is fed to the analytical column 16 via the first port 61 and second port 62. The sample from the needle is introduced by the fourth port 64 and led to the sample loop 70 via the third port 63 before being discharged into the drain via the sixth port 66 and fifth port 65.

When the sample loop 70 is filled with the sample in this manner, as shown in FIG. 6A, the valve is switched. The mobile phase supplied from the mixer 14 is led to the sample loop 70 via the first port 61 and sixth port 66. The sample in the sample loop 70 is forced out by the mobile phase before being led to the analytical column 16 via the third port 63 and second port 62.

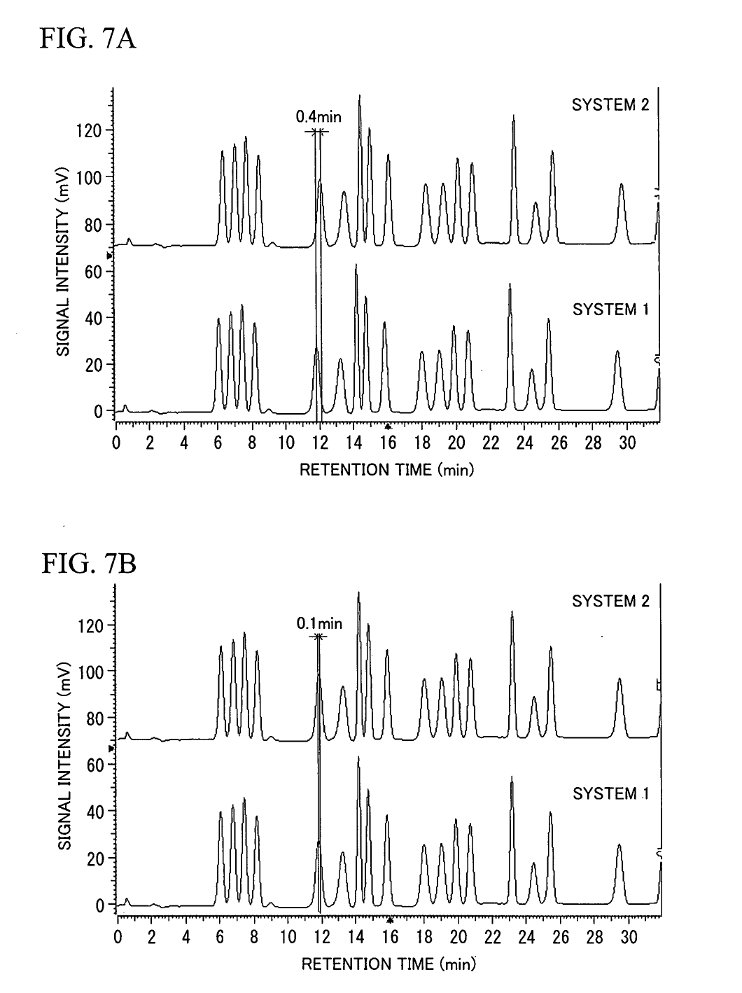

FIGS. 7A and 7B shows simulation results of amino acid analysis by the liquid chromatograph apparatus. FIG. 7A is an analysis result obtained by the conventional operation method and FIG. 7B is an analysis result obtained by the operation method according to the present invention. In these graphs, the horizontal axis indicates a retention time and the vertical axis indicates signal intensity from a detector. The retention time is an elapsed time after starting data collection.

An upper graph in FIG. 7A is an analysis result obtained from a liquid chromatograph apparatus having an instrumental error and a lower graph in FIG. 7A is an analysis result obtained from a liquid chromatograph apparatus having no instrumental error, that is, a standard apparatus. As shown in the figure, the retention time when a peak appears is 0.4 min later in the analysis result obtained from the liquid chromatograph apparatus having an instrumental error as compared with that obtained from the standard apparatus. This is because, in the liquid chromatograph apparatus having an instrumental error, there is an instrumental error, that is, the dwell volume DV is larger than that of the standard apparatus.

An upper graph in FIG. 7B is an analysis result obtained from the liquid chromatograph apparatus having an instrumental error and a lower graph in FIG. 7B is an analysis result obtained from the liquid chromatograph apparatus having no instrumental error, that is, the standard apparatus. As shown in the figure, the retention time when a peak appears is 0.1 min later in the analysis result obtained from the liquid chromatograph apparatus having an instrumental error as compared with that obtained from the standard apparatus. That is, compared with FIG. 7A, the delay of the time when a peak appears is smaller. This is because, in the liquid chromatograph apparatus having an instrumental error, the injection time of a sample by the auto sampler is adjusted.

FIG. 8 is a diagram exemplifying a dwell volume setting screen displayed in a displayed apparatus of the liquid chromatograph apparatus in the present invention. In the illustrated dwell volume setting screen, advanced gradient is checked and 300 μL is set to dwell volume. The mobile phase arrival time is determined by substituting the dwell volume set here for DV in Formula 1. The start time of gradient liquid feeding is set based on the mobile phase arrival time.

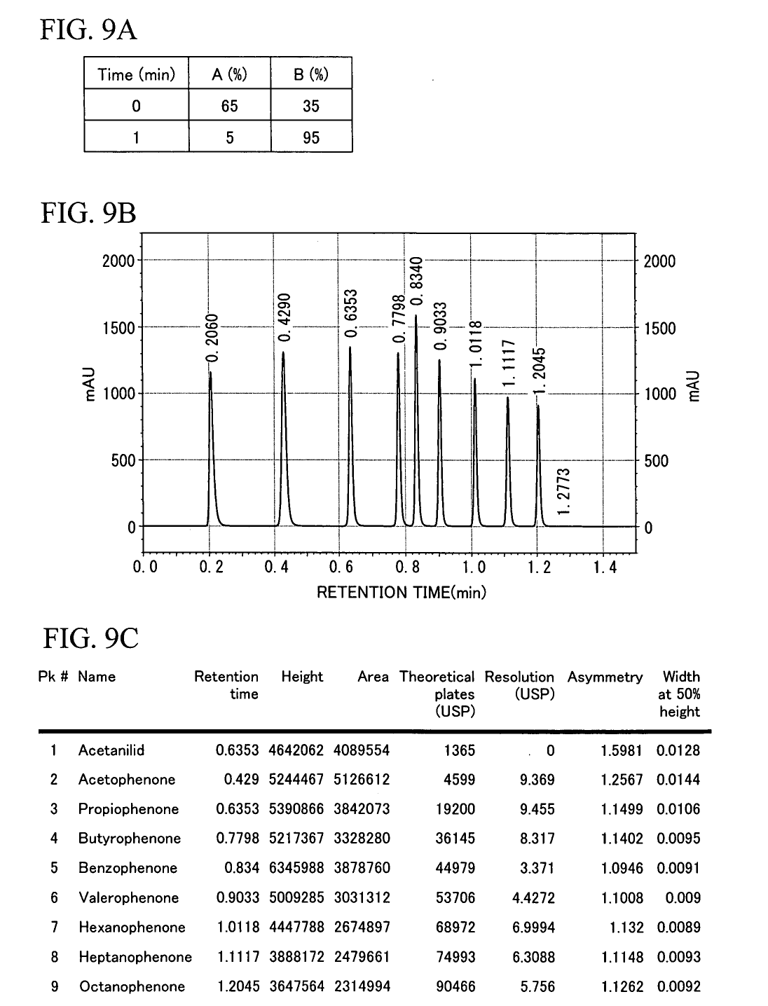

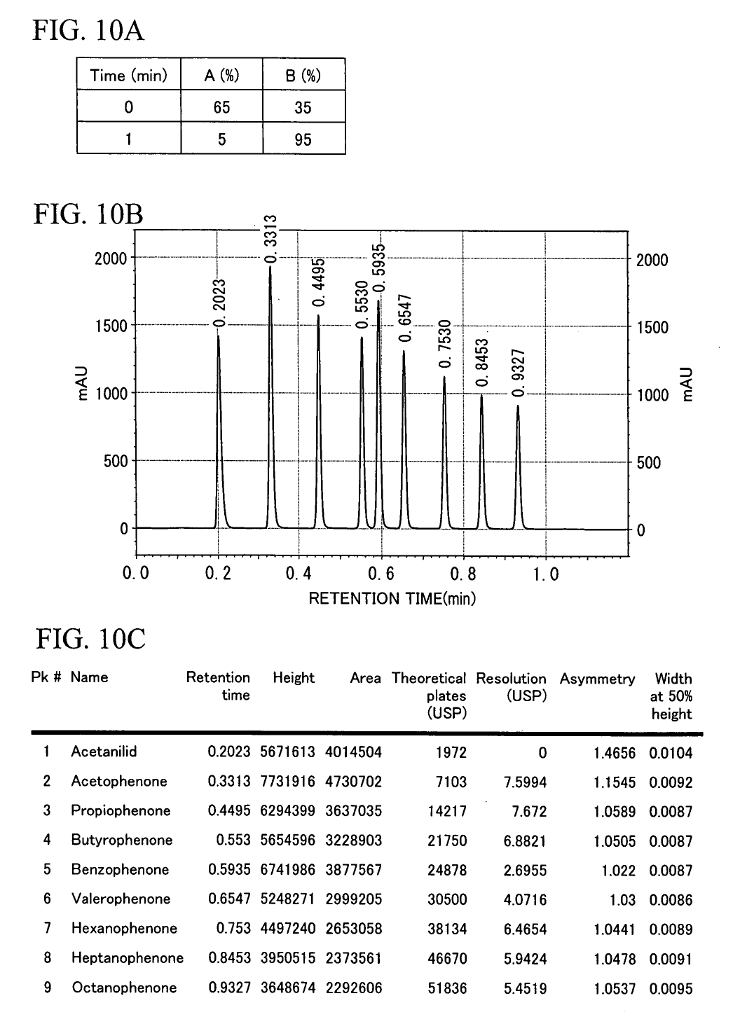

Experimental results will be described with reference to FIGS. 9A, 9B and 9C and FIGS. 10A, 10B and 10C. FIGS. 9A, 9B and 9C shows experimental results by a conventional method by which no dwell volume is set and FIGS. 10A, 10B and 10C shows experimental results by the method according to the present method by which the dwell volume is set. Experimental conditions are as follows:
Sample dilution: Acetonitrile
Sample injection amount: 100 ppm, 5 μL
Detector: UV247 nm (high pressure-resistant semi-microcell, response: 0.01 s, SP: 10 ms)

FIG. 9A and FIG. 10A show gradient programs. The same gradient program is used in the conventional method and the method according to the present invention. Conditions for the gradient program are as follows:
A: Water
B: Acetonitrile
Temperature: 40° C.
Flow rate: 1.2 mL/min

As shown in the figures, while the ratio of water to acetonitrile was at first 65:35, the ratio changed to 5:95 a minute later.

FIG. 9B and FIG. 10B are graphs of measurement results and FIG. 9C and FIG. 10C are peak values of measurement results. The time when a peak appears is compared between the conventional method shown in FIG. 9B and FIG. 9C and the method of the present invention shown in FIG. 10B and FIG. 10C. The time when a peak appears becomes earlier when the method according to the present invention is used as compared with the conventional method. As shown in FIG. 9B and FIG. 9C, the time when the ninth peak appears is 1.2 min when the conventional method is used. As shown in FIG. 10B and FIG. 10C, on the other hand, the time when the ninth peak appears is 0.93 min when the method according to the present invention is used. Therefore, the analysis time can be reduced when the analysis method according to the present invention is used.

Further, the peak width will be compared between the conventional method shown in FIG. 9C and the method according to the present invention shown in FIG. 10C. As is evident from comparison between peak widths (half-value widths) according to the conventional method shown in the right-end field of FIG. 9C and peak widths (half-value widths) according to the method in the present invention shown in the right-end field of FIG. 10C, the peak width according to the method in the present invention is narrower than that according to the conventional method. That is, according to the present invention, an effect of higher separation accuracy can be gained.

Examples of the present invention have been described above, but the present invention is not limited to the above examples and those skilled in the art will easily understand that various modifications can be made within the scope as defined by the appended claims.

According to the present invention, an instrumental error of a dead volume of hardware concerning time delay of the gradient elution method can be compensated for by using adjustment parameters for data processing of software so that an instrumental error between systems, such as the retention time of a peak can be suppressed.

What is claimed is:

1. A liquid chromatograph apparatus comprising: a pump for performing gradient liquid feeding to supply a plurality of mobile phases at a time-varying rate; an auto sampler for injecting a sample into the mobile phase; and an analytical column for separating components contained in the sample, wherein
a mobile phase arrival time taken for the mobile phase fed from the pump to reach the analytical column is measured in advance and, when a time corresponding to the mobile phase arrival time passes after starting gradient liquid feeding, the sample is injected into the mobile phase from the auto sampler.

2. The liquid chromatograph apparatus according to claim 1, wherein data collection is started immediately after sample injection by the auto sampler is started or after a predetermined time passes.

3. The liquid chromatograph apparatus according to claim 1, wherein if a flow rate of the pump is F.R. and a dwell volume, which is a total volume of a flow channel from an outlet of the pump to an entrance of the analytical column, is DV, the mobile phase arrival time is expressed by a formula shown below:
T=DV/F.R.
T: Mobile phase arrival time (s)
DV: Dwell volume (μL)
F.R.: Pump Rate (Flow rate)(μL/s)

4. The liquid chromatograph apparatus according to claim 1, wherein the auto sampler includes an injection valve and a sample loop, wherein the sample is injected into the mobile phase by switching the injection valve.

5. The liquid chromatograph apparatus according to claim 1, further comprising a detector for detecting components separated by the analytical column.

6. The liquid chromatograph apparatus according to claim 5, further comprising a data processing part for collecting output data from the detector.

7. The liquid chromatograph apparatus according to claim 6, wherein the data processing part includes a parameter storage part for storing the mobile phase arrival time.

8. The liquid chromatograph apparatus according to claim 1, further comprising a mixer for mixing mobile phases supplied from the pump.

9. The liquid chromatograph apparatus according to claim 1, further comprising a reagent pump for supplying a reagent to components separated by the analytical column and a reaction coil for mixing the components and the reagent.

10. The liquid chromatograph apparatus according to claim 1, further comprising an input device into which data and instructions are input by a user and a display device for displaying a dwell volume setting screen used for inputting a dwell volume, wherein the dwell volume setting screen is provided with a field into which the dwell volume to be set by the user is input.

11. A method of analyzing a sample by means of a liquid chromatograph apparatus comprising:
a mobile phase arrival time measuring step of measuring a mobile phase arrival time taken for a mobile phase started from a pump to reach an analytical column via an auto sampler;
a mobile phase supply step of flowing the mobile phase up to the analytical column via the auto sampler by activating the pump;
a gradient liquid feeding start step of starting gradient liquid feeding by which a plurality of mobile phases are supplied at a time-varying rate by means of the pump; and
a sample injection start step of starting sample injection by the auto sampler when a time corresponding to the mobile phase arrival time passes after starting the gradient liquid feeding.

12. The method of analyzing a sample according to claim 11, further comprising:
a data collection start step of collecting data immediately after sample injection by the auto sampler is started or after a predetermined time passes.

13. A liquid chromatograph comprising: a plurality of pumps for performing gradient liquid feeding to supply a plurality of mobile phases at a time-varying rate, an auto sampler for injecting a sample into the mobile phase, an analytical column for separating components contained in the sample from the mobile phase fed from the auto sampler, and a detector for detecting components separated by the analytical column, wherein
a mobile phase arrival time taken for the mobile phase started from the pump to reach the analytical column via the auto sampler is measured in advance and, when a time corresponding to the mobile phase arrival time passes after starting gradient liquid feeding by the pump, sample injection by the auto sampler is started.

14. The liquid chromatograph according to claim 13, wherein data collection from the detector is started immediately after sample injection by the auto sampler is started or after a predetermined time passes.

15. The liquid chromatograph according to claim 13, further comprising a reagent pump for supplying a reagent to components separated by the analytical column and a reaction coil for mixing the components and the reagent, wherein reaction products from the reaction coil are detected by the detector.
